(19) United States
(12) Patent Application Publication
(10) Pub. No.: US 2014/0045046 A1
(43) Pub. Date: Feb. 13, 2014

(54) WELDING METHOD OF SEALED SECONDARY BATTERY, SEALED SECONDARY BATTERY, AND CAP BODY

(71) Applicant: KABUSHIKI KAISHA TOSHIBA, Tokyo (JP)

(72) Inventor: Tetsuo SAKAI, Tokyo (JP)

(73) Assignee: Kabushiki Kaisha Toshiba, Tokyo (JP)

(21) Appl. No.: 13/832,414

(22) Filed: Mar. 15, 2013

(30) Foreign Application Priority Data
Aug. 13, 2012 (JP) 2012-179292

(51) Int. Cl. H01M 2/06; H01M 2/04; H01M 10/04

(52) U.S. Cl. CPC H01M 2/06; H01M 10/04; H01M 2/0404; H01M 2/043
USPC 429/175; 29/623.1; 429/179

(57) ABSTRACT

A welding method of a sealed secondary battery provided with a casing configured to encase therein electrodes and an electrolyte, a cap body configured to cover the casing, and two terminals inserted into holes provided in the cap body, connected to a pair of electrodes, and formed of a material including composition different from a material of the lead includes crushing and spreading the distal end side of each of two terminals along a cap body, and carrying out continuous welding along a boundary line between a circumference of the distal end side of the terminal, and the cap body, and alternately and repetitively by way of a position on the terminal side of the boundary line regarded as a reference line, and a position on the cap body side of the boundary line.

### CROSS-REFERENCE TO RELATED APPLICATIONS

This application is based upon and claims the benefit of priority from Japanese Patent Application No. 2012-179292, filed Aug. 13, 2012, the entire contents of which are incorporated herein by reference.

### FIELD

Embodiments described herein relate generally to a welding method of a sealed secondary battery with parts at which different types of metallic materials are welded together, and sealed secondary battery and cap body formed by using the welding method.

### BACKGROUND

A sealed secondary battery is provided with a casing configured to encase therein electrodes and an electrolyte, a cap body configured to cover the casing, terminals, and a lead provided on the cap body.

After being inserted into a hole provided in the cap body, the terminal is swaged from the back side of the cap body by means of a pressing machine. At this time, an insulator is present between the terminal and cap body, and the terminal and cap body are insulated from each other. The terminal is spread to be formed into a disk-like shape, and the circumferential part thereof is laser-welded to the back side of the cap body to be joined thereto. Welding is carried out continuously or intermittently along the circumferential part of the terminal.

It should be noted that as the material for the terminal, for example, a material such as an aluminum alloy 5052 material or the like is used, and as the material for the cap body, a pure aluminum material (1050 material or the like) having higher thermal conductivity than the 5052 material is used.

In the above-mentioned welding method of the sealed secondary battery, there has been the following problem. That is, although the aluminum alloy 5052 material and the pure aluminum material 1050 material are identical to each other in coefficient of linear expansion, they largely differ from each other in thermal diffusivity, i.e., they have, for example, 57.0 and 92.9 mm²/s, respectively, as values of the thermal diffusivity. For this reason, when continuous welding is carried out, a significant thermal stress is caused between the terminal and cap body by the heat received at the time of welding, and a crack occurs in some cases. When a crack occurs, there is the possibility of the crack becoming a cause of an increase in the electrical resistance at the joint part.

Further, when intermittent welding in which radiation and non-radiation of laser are repeated is carried out, the laser-applied part is rapidly cooled at the endpoint of welding, and thus there is a problem that a crack is liable to occur.

Thus, a welding method of a sealed secondary battery with a low rate of crack occurrence is preferable.

### BRIEF DESCRIPTION OF THE DRAWINGS

FIG. 1 is an exploded perspective view showing a sealed secondary battery according to an embodiment.

FIG. 2 is an plan view showing a cap body incorporated in the sealed secondary battery.

FIG. 3 is an explanatory view showing a terminal welding method used to form the cap body.

FIG. 4 is an explanatory view showing an incidence angle of a welding locus with a boundary line, and crack length which are derived from an amplitude of welding obtained from an experimental result of the terminal welding method used to form the cap body.

### DETAILED DESCRIPTION

A welding method of a sealed secondary battery according to an embodiment comprises: crushing and spreading, along a cap body including a lead to be connected to an electricity generation element including an electrolyte, the distal end side of each of two terminals inserted into holes provided in the cap body, connected to a pair of electrodes, and formed of a material including composition different from a material of the lead; and carrying out continuous welding along a boundary line between a circumference of the distal end side of the terminal, and the cap body, and alternately and repetitively by way of a position on the terminal side of the boundary line regarded as a reference line, and a position on the cap body side of the boundary line to form a sinuous welding locus a period of which satisfies a condition B/2<W<L/2π, where W is amplitude, L is sinuous period, and B is weld width, and at least part of which includes positions outwardly protruded from the terminal side toward the cap body side.

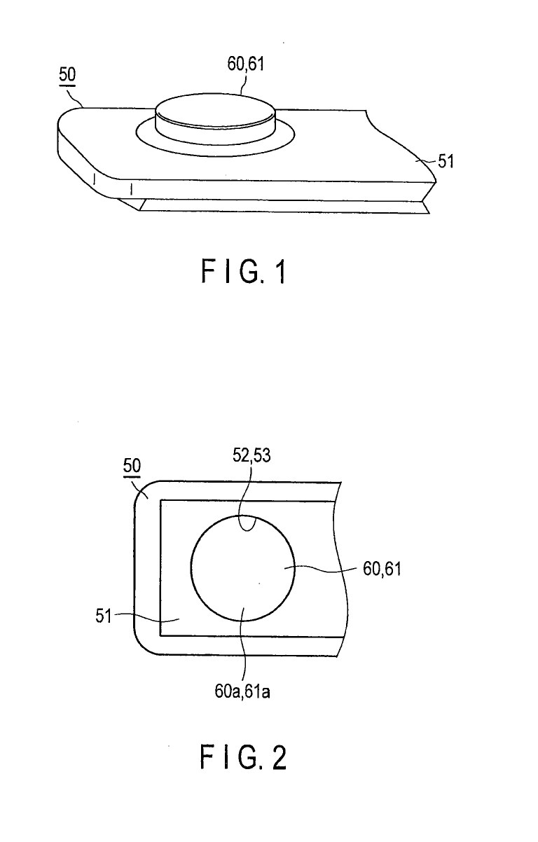

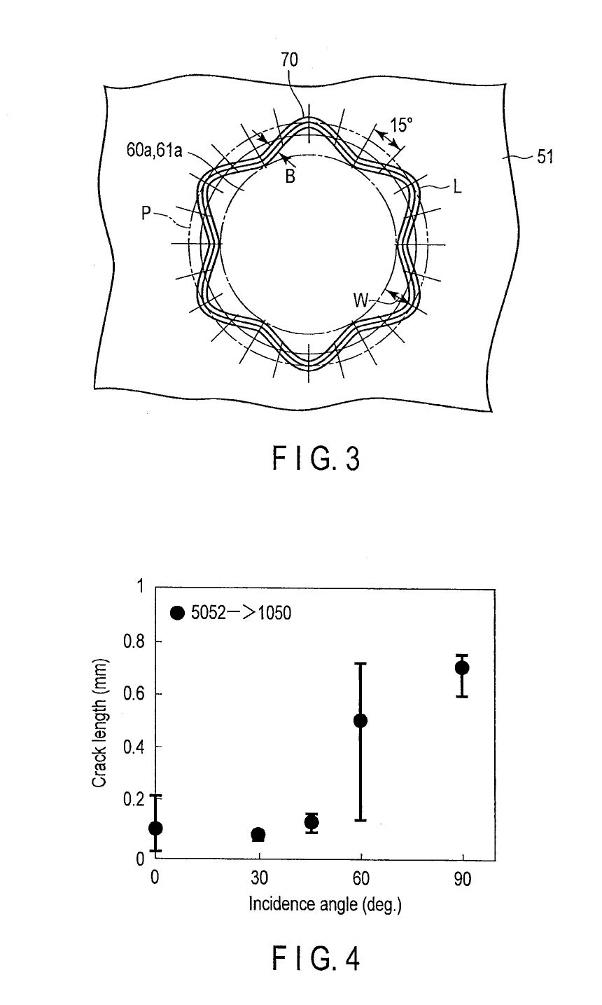

FIG. 1 is a perspective view showing a cap body 50 incorporated in a sealed secondary battery according to an embodiment. FIG. 3 is an explanatory view showing a terminal welding method used to form the cap body 50. FIG. 4 is an explanatory view showing an incidence angle of a welding locus with a boundary line P, and crack length which are derived from an amplitude of welding obtained from an experimental result.

The sealed secondary battery is provided with a casing having an opening part at an upper part thereof, and configured to encase therein an electrolyte and a pair of electrodes, cap body 50 configured to cover the opening part of the casing, and a pair of terminals 60 and 61 connected to the pair of electrodes.

As shown in FIG. 2, the cap body 50 is provided with a cap main body 51, and the terminals 60 and 61 made of an aluminum alloy material different from that of the cap main body 51 in thermal diffusivity.

The cap main body 51 is formed of a pure aluminum material 1050 material (pure aluminum material or a first aluminum alloy material) thermal diffusivity of which is about 92.9 mm²/s, and the terminals 60 and 61 to be described later are formed of an aluminum alloy 5052 material (second aluminum alloy material) thermal diffusivity of which is about 57.0 mm²/s. The aluminum alloy 5052 material contains 2.56% magnesium. It should be noted that each of the above metallic materials has a linear expansion coefficient of 24 μm/m·° C.

A distal end 60a or 61a of each of the terminals 60 and 61 is provided on the back side (the other side) of the cap main body 51. The distal end 60a or 61a is spread to be formed into a disk-like shape along the back side of the cap main body 51. As shown in FIG. 3, a joint part 70 formed by carrying out continuous welding along a boundary line P between a circumference of the distal end 60a or 61a and cap main body 51, and alternately and repetitively by way of a position on the distal end 60a or 61a side of the boundary line P regarded as a reference line, and position on the cap main body 51 side of the boundary line P is provided.

The sealed secondary battery configured as described above is manufactured by the following process. That is, distal ends 60a and 61a of a pair of terminals 60 and 61 are inserted into a pair of hole parts 52 and 53 provided in a cap main body 51. Next, each of the distal ends 60a and 61a is crushed to be formed into a disk-like (circular) shape by using a pressing machine or the like to thereby be swaged in order that the terminal 60 or 61 may not come out of the hole part 52 or 53.

Next, continuous welding is carried out to form a sinuous welding locus along a boundary line P between a circumference of the distal end 60a or 61a and cap main body 51, and alternately and repetitively by way of a position on the distal end 60a or 61a side of the boundary line P regarded as a reference line, and position on the cap main body 51 side of the boundary line P under the condition to be described later by laser welding. It should be noted that the welding is set in such a manner that the welding locus is a sinuous locus part of which has positions outwardly protruded from the terminal 60 or 61 side toward the cap main body 51 side.

Setting of the amplitude W, and sinuous period L of the continuous welding locus will be described below. That is, when the amplitude is W, sinuous period is L, and weld width is B, setting is made to satisfy the condition B/2<W<L/2π.

For example, when it is assumed that a diameter of the circular distal end 60a or 61a is 5.4 mm, and width B of sinuous laser welding having six peaks/troughs is 0.6 mm, the amplitude W of the sinuous welding locus becomes 0.3 to 0.45 mm. When the welding makes a round, the joint part 70 is formed.

The derivation process of the above-mentioned condition will be described below. That is, the formula expressing an arbitrary wave is y=W sin ωx. The inclination of the wave is defined as follows. It should be noted that from an experimental value, it is essential that the gradient of a tangential component at the point of intersection of the welding locus with the joint surface be 45° or less, and hence the following expressions are obtained:

dy/dx=Wω cos ωx<1, ω=2π/L

In order to obtain a locus in which the node overlaps the joint surface, positions satisfying ωx=0, π, 2π are obtained, and cos ωx=1 is also obtained. Accordingly, from Wω<1, W<L/2π is obtained.

On one hand, the amplitude W is greater than the weld width B, and hence W>B/2 is obtained. Accordingly, the welding locus should satisfy the above-mentioned condition B/2<W<L/2π.

On the other hand, setting is made in such a manner that the welding locus has a sinuous locus in which at least some parts are protruded from the terminal 60 or 61 side toward the cap main body 51 side. The reason for the above will be described.

In the welding, the metallic material is melted/evaporated at a keyhole located at a position to which the beam is applied. When the beam is moved, a weld pool constituted of the molten metallic material is formed with the keyhole at a head thereof. At this time, a flow of the molten metallic material occurs from the keyhole side toward the rear side.

Accordingly, when the welding is advanced from the cap main body 51 side constituted of the pure aluminum material toward the terminal 60 or 61 side constituted of the aluminum alloy containing magnesium, the aluminum alloy containing magnesium flows into the pure aluminum material side. The joint part 70 formed in this way is made to contain magnesium, and from an experimental result, the rate of crack occurrence becomes high, and the crack length becomes large at the joint part 70.

Conversely, when the welding is advanced from the terminal 60 or 61 side constituted of the aluminum alloy containing magnesium toward the cap main body 51 side constituted of the pure aluminum material, the aluminum alloy containing magnesium never flows into the pure aluminum material side. The joint part 70 formed in this way contains only a very small amount (for example, 1% or less) of magnesium, has a low rate of crack occurrence, and the crack length becomes small at the joint part 70.

It should be noted that, as shown in FIG. 4, it can be seen that there is such a relationship between the incidence angle of the welding locus with the boundary line P, and crack length which are derived from the amplitude of the welding locus that when the incidence angle is 45° or less, and the welding locus is formed from the terminal 60 or 61 side toward the cap maim body 51 side in terms of direction, the crack length becomes smaller.

According to such a welding method of a sealed secondary battery, even when the difference between the cap main body 51 and terminal 60 or 61 which are objects of welding in thermal diffusivity is great, it is possible to reduce the number of positions at which the welding passes across a part (boundary line P) having a great difference in thermal diffusivity, and hence it can be expected that thermal stress attributable to a difference in expansion amount will be relieved.

Furthermore, an angle at which the joint part 70 intersects the boundary line P is about 30°, and thus the joint width at the boundary line P becomes sufficiently large. Accordingly, the thermal stress attributable to a difference in expansion amount is dispersed, and hence it is possible to prevent a crack from occurring. Further, by preventing magnesium from flowing into the joint part 70, it becomes possible to reduce the rate of crack occurrence, and shorten the crack length.

Moreover, by making the welding locus have a sinuous shape, the joint part 70 on the boundary between the terminal 60 or 61, and cap main body 51 is made intermittent. Thereby, the welding method has a merit that even when a crack occurs in part of the joint part 70, the crack does not extend to an adjacent joint part 70, and conduction is maintained.

As described above, according to the welding method of a sealed secondary battery according to this embodiment, it is possible to carry out stable welding with a low rate of crack occurrence, and obtain a sealed secondary battery 10 and cap body 50 having high degrees of quality and reliability.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A welding method of a sealed secondary battery comprising:
crushing and spreading, along a cap body including a lead to be connected to an electricity generation element including an electrolyte, the distal end side of each of two terminals inserted into holes provided in the cap body, connected to a pair of electrodes, and formed of a material including composition different from a material of the lead; and
carrying out continuous welding along a boundary line between a circumference of the distal end side of the terminal, and the cap body, and alternately and repetitively by way of a position on the terminal side of the boundary line regarded as a reference line, and a position on the cap body side of the boundary line to form a sinuous welding locus a period of which satisfies a condition B/2<W<L/2π, where W is amplitude, L is sinuous period, and B is weld width, and at least part of which includes positions outwardly protruded from the terminal side toward the cap body side.

2. The welding method of a sealed secondary battery according to claim 1, wherein
each of the material of the lead, and the material of the terminal possesses an identical thermal expansion coefficient.

3. A sealed secondary battery comprising:
a casing configured to encase therein electrodes and an electrolyte;
a cap body configured to cover the casing, and including a lead to be connected to an electricity generation element including an electrolyte;
two terminals inserted into holes provided in the cap body, connected to a pair of electrodes, and formed of a material including composition different from a material of the lead; and
a continuously welded joint part including a sinuous welding locus which is formed along a boundary line between a circumference of the distal end side of the terminal spread along the cap body, and the cap body, and alternately and repetitively by way of a position on the terminal side of the boundary line regarded as a reference line, and a position on the cap body side of the boundary line, a period of which satisfies a condition B/2<W<L/2π, where W is amplitude, L is sinuous period, and B is weld width, and at least part of which includes positions outwardly protruded from the terminal side toward the cap body side.

4. The sealed secondary battery according to claim 3, wherein
each of the material of the lead, and the material of the terminal possesses an identical thermal expansion coefficient.

5. A cap body configured to cover a casing encasing therein a pair of electrodes and an electrolyte, and including a lead to be connected to an electricity generation element including an electrolyte comprising:
a plate-like cap main body;
a pair of hole parts provided in the cap main body;
a pair of terminals inserted into the pair of hole parts from one surface side of the cap main body, connected to the pair of electrodes, and formed of a material including composition different from a material of the lead; and
a continuously welded joint part provided on the other surface side of the cap main body, and including a sinuous welding locus which is formed along a boundary line between a circumference of the distal end side of the terminal spread along the cap body, and the cap body, and alternately and repetitively by way of a position on the terminal side of the boundary line regarded as a reference line, and a position on the cap body side of the boundary line, a period of which satisfies a condition B/2<W<L/2π, where W is amplitude, L is sinuous period, and B is weld width, and at least part of which includes positions outwardly protruded from the terminal side toward the cap body side.

6. The cap body according to claim 5, wherein
each of the material of the lead, and the material of the terminal possesses an identical thermal expansion coefficient.
